(19) United States
(12) Patent Application Publication
(10) Pub. No.: US 2026/0195351 A1
(43) Pub. Date: Jul. 9, 2026

(54) DOCUMENT SEARCH SUPPORT METHOD, PROGRAM, AND DOCUMENT SEARCH SUPPORT SYSTEM

(71) Applicant: SEMICONDUCTOR ENERGY LABORATORY CO., LTD., Atsugi-shi, Kanagawa-ken (JP)

(72) Inventors: Junpei MOMO, Sagamihara, Kanagawa (JP); Yoshiaki OIKAWA, Atsugi, Kanagawa (JP); Natsuko TAKASE, Isehara, Kanagawa (JP)

(21) Appl. No.: 19/131,557

(22) PCT Filed: Nov. 17, 2023
(86) PCT No.: PCT/IB2023/061624

§ 371 Date: May 21, 2025

(30) Foreign Application Priority Data
Nov. 24, 2022 (JP) 2022-187370

(51) Int. Cl. G06F 16/332; G06F 16/35

(52) U.S. Cl. CPC G06F 16/332; G06F 16/35

(57) ABSTRACT

An appropriate search formula is provided to search a desired document group. Document search is simplified. Learning of a classifier is performed using, as learning data, a vector based on an element included in data of a document and a determination label on whether or not the document is a desired document, and the classifier is analyzed to extract two or more elements having high levels of importance. With use of the two or more extracted elements, a first search formula is created such that the number of first search terms is small, many of the desired documents include at least one of the first search terms, and many other documents include none of the first search terms, and a second search formula is created such that the number of second search terms is small and many other documents include at least one of the second search terms. A third search formula for searching the desired document is created using the two search formulae and output. In addition, a result of searching using the third search formula is output.

### TECHNICAL FIELD

One embodiment of the present invention relates to a document search support method. Another embodiment of the present invention relates to a program capable of supporting document search. Another embodiment of the present invention relates to a document search support system.

### BACKGROUND ART

Examples of tasks relating to patents include the prior art search, acquisition of patent right, and patent invalidity search. Prior art search regarding an invention before its application enables the confirmation whether or not there is a relevant intellectual property right. Domestic or foreign patent documents, papers, and the like found through the prior art search are helpful in confirming the novelty and non-obviousness of the invention and determining whether to file the application. In addition, patent invalidity search is conducted on the patent documents, whereby it is possible to find whether there is a possibility of invalidation of the patent right owned by an applicant or whether the patent rights owned by others can be rendered invalid.

Since the tasks relating to patents are wide-ranging, support systems for the tasks related to patents, such as a support system for creating patent application documentation, a patent-information analysis system, and a patent search system, have been developed in recent years. Patent Document 1 discloses a patent document search technology that is a combination of the keyword search and the similarity search.

### REFERENCE

### Patent Document

[Patent Document 1] Japanese Published Patent Application No. 2018-73309

### SUMMARY OF THE INVENTION

### Problems to be Solved by the Invention

In order to search a desired document by text search, it is necessary to select an appropriate keyword. To increase the accuracy of the search, it is desirable to not only use a keyword relating to the desired document but also to designate a keyword for excluding an unnecessary document. In addition, another way to say a selected keyword (e.g., an equivalent word and a synonym) is desirably taken into consideration. Thus, creating an appropriate search query needs trial and error and an operator having a high skill level.

Search results obtained by a mechanism capable of searching with a simple search query, such as a web search engine, might be subjected to intentional operation or induced by an algorithm such as page ranking, thereby having a lack of objectivity.

There may be a classification mechanism built for some documents. Examples of such a classification mechanism include a classification method for books and patent classification. Specifically, patent documents can be assigned to patent classification such as CPC (Cooperative Patent Classification), IPC (International Patent Classification), FI (File Index), or F-term (File Forming Term). However, the number of patent classification items is extremely large, and it is sometimes difficult to select an appropriate item in order to search a desired patent.

An object of one embodiment of the present invention is to provide an appropriate search formula for a user to search a desired document group. Another object of one embodiment of the present invention is to provide a document search support system that can be operated easily by a user. Another object of one embodiment of the present invention is to provide a document search support method or a document search support system, which enables a user to obtain needed information efficiently. Another object of one embodiment of the present invention is to achieve highly accurate document search, especially for a document relating to intellectual property, with an easy input method.

Note that the description of these objects does not preclude the existence of other objects. One embodiment of the present invention does not necessarily need to achieve all of these objects. Other objects can be derived from the description of the specification, the drawings, and the claims.

### Means for Solving the Problems

One embodiment of the present invention is a method for supporting document search including obtaining data of a plurality of documents, receiving a document that is part of the plurality of documents as a desired document, classifying the plurality of documents into a first document group including the desired document and a second document group including the remaining document, performing learning of a classifier using, as learning data, a vector based on an element included in the data and a determination label on whether or not the document is the desired document in each of the plurality of documents, analyzing the classifier to extract two or more elements having high levels of importance from the elements, classifying the extracted elements into a first group included in the first document group and a second group not included in the first document group, generating, using an element included in the first group, first search terms a number of which is two or more and two times or less a number of the elements of the first group, and creating, using the first search terms, a first search formula such that 50% or more of documents included in the first document group include at least one of the first search terms and 50% or more of documents included in the second document group include none of the first search terms, generating, using an element included in the second group, second search terms a number of which is two or more and two times or less a number of the elements of the second group, and creating, using the second search terms, a second search formula such that 50% or more of the documents included in the second document group include at least one of the second search terms, and outputting one or both of a third search formula created using the first search formula and the second search formula and a result of searching the plurality of documents using the third search formula.

One embodiment of the present invention is a method for supporting document search including obtaining data of a plurality of documents, receiving a document that is part of the plurality of documents as a desired document and receiving a document that is another part of the plurality of documents as an undesired document, classifying the plurality of documents into a first document group including the desired document, a second document group including the undesired document, and a third document group including the remaining document, performing learning of a classifier using, as learning data, a vector based on an element included in the data and a determination label on whether or not the document is the desired document in each document included in the first document group and the second document group, analyzing the classifier to extract two or more elements having high levels of importance from the elements, classifying the extracted elements into a first group included in the first document group and a second group not included in the first document group, generating, using an element included in the first group, first search terms a number of which is two or more and two times or less a number of the elements of the first group, and creating, using the first search terms, a first search formula such that 50% or more of documents included in the first document group include at least one of the first search terms and 50% or more of documents included in the second document group include none of the first search terms, generating, using an element included in the second group, second search terms a number of which is two or more and two times or less a number of the elements of the second group, and creating, using the second search terms, a second search formula such that 50% or more of the documents included in the second document group include at least one of the second search terms, and outputting one or both of a third search formula created using the first search formula and the second search formula and a result of searching the plurality of documents using the third search formula.

It is preferable that the second search formula be created after the first search formula is created. In this case, the second search formula is preferably created such that 50% or more of documents extracted by the first search formula from the second document group include at least one of the second search terms.

The classifier is preferably a classifier using random forest.

The first search formula is preferably created using a genetic algorithm.

The second search formula is preferably created using a genetic algorithm.

The element included in the data is preferably a word.

One embodiment of the present invention is a program having a function of making a processor execute any of the above methods for supporting document search.

One embodiment of the present invention is a document search support system including a reception unit, a storage unit, a processing unit, and an output unit; the reception unit has a function of receiving a selection of a desired document; the storage unit includes a classifier; the processing unit has a function of generating a vector on the basis of an element included in data of each of a plurality of documents, a function of assigning a determination label on whether or not the document is the desired document to each of the plurality of documents on the basis of the selection received by the reception unit, a function of performing learning of the classifier using the vector and the determination label as learning data, a function of analyzing the classifier to extract two or more elements having high levels of importance, and a function of creating a search formula using the elements having high levels of importance; and the output unit has a function of outputting the search formula.

One embodiment of the present invention is a document search support system including a reception unit, a storage unit, a processing unit, and an output unit; the reception unit has a function of receiving a selection of a desired document; the storage unit includes a classifier; the processing unit has a function of classifying a plurality of documents into a first document group including the desired document and a second document group including the remaining document, a function of generating a vector of the document on the basis of an element included in data of the document, a function of assigning a determination label on whether or not the document is the desired document to each of the plurality of documents on the basis of the selection received by the reception unit, a function of performing learning of the classifier using the vector and the determination label as learning data, a function of analyzing the classifier to extract two or more elements having high levels of importance, a function of classifying the elements having high levels of importance into a first group included in the first document group and a second group not included in the first document group, a function of generating, using an element included in the first group, first search terms a number of which is two or more and two times or less a number of the elements of the first group, and creating, using the first search terms, a first search formula such that 50% or more of documents included in the first document group include at least one of the first search terms and 50% or more of documents included in the second document group include none of the first search terms, a function of generating, using an element included in the second group, second search terms a number of which is two or more and two times or less a number of the elements of the second group, and creating, using the second search terms, a second search formula such that 50% or more of the documents included in the second document group include at least one of the second search terms, and a function of creating a third search formula using the first search formula and the second search formula; and the output unit has a function of outputting the third search formula.

One embodiment of the present invention is a document search support system including a reception unit, a storage unit, a processing unit, and an output unit; the reception unit has a function of receiving a selection of a desired document and an undesired document; the storage unit includes a classifier; the processing unit has a function of classifying a plurality of documents into a first document group including the desired document, a second document group including the undesired document, and a third document group including the remaining document, a function of generating a vector of the document on the basis of an element included in data of the document, a function of assigning a determination label on whether or not the document is the desired document to each of the plurality of documents on the basis of the selection received by the reception unit, a function of performing learning of the classifier using the vector and the determination label as learning data, a function of analyzing the classifier to extract two or more elements having high levels of importance, a function of classifying the elements having high levels of importance into a first group included in the first document group and a second group not included in the first document group, a function of generating, using an element included in the first group, first search terms a number of which is two or more and two times or less a number of the elements of the first group, and creating, using the first search terms, a first search formula such that 50% or more of documents included in the first document group include at least one of the first search terms and 50% or more of documents included in the second document group include none of the first search terms, a function of generating, using an element included in the second group, second search terms a number of which is two or more and two times or less a number of the elements of the second group, and creating, using the second search terms, a second search formula such that 50% or more of the documents included in the second document group include at least one of the second search terms, and a function of creating a third search formula using the first search formula and the second search formula; and the output unit has a function of outputting the third search formula.

The processing unit preferably has a function of searching the plurality of documents using the third search formula. The output unit preferably has a function of outputting a result of searching the documents.

### Effect of the Invention

According to one embodiment of the present invention, an appropriate search formula for a user to search a desired document group can be provided. According to one embodiment of the present invention, a document search support system that can be operated easily by a user can be provided. According to one embodiment of the present invention, a document search support method or a document search support system, which enables a user to obtain needed information efficiently, can be provided. According to one embodiment of the present invention, highly accurate document search, especially for a document relating to intellectual property, can be achieved with an easy input method.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a diagram illustrating an example of a system relating to document search.

FIG. 2 is a diagram showing an example of a document search support system.

FIG. 3 is a diagram illustrating an example of a document search support method.

FIG. 4 is a diagram illustrating an example of a document search support method.

FIG. 5A, FIG. 5B, FIG. 5C1, and FIG. 5C2 are diagrams each describing an example of a document search support method.

FIG. 6 is a diagram describing an example of a document search support method.

FIG. 7 is a diagram showing an example of a document search support system.

FIG. 8 is a diagram illustrating an example of a document search support system.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

Note that in structures of the invention described below, the same portions or portions having similar functions are denoted by the same reference numerals in different drawings, and the description thereof is not repeated. The same hatching pattern is used for portions having similar functions, and the portions are not especially denoted by reference numerals in some cases.

The position, size, range, or the like of each component illustrated in drawings does not represent the actual position, size, range, or the like in some cases for easy understanding. Therefore, the disclosed invention is not necessarily limited to the position, size, range, or the like disclosed in the drawings.

Note that in this specification and the like, ordinal numbers such as “first” and “second” are used for convenience and do not limit the number of components or the order of components (e.g., the order of steps or the stacking order of layers). An ordinal number used for a component in a certain part in this specification is not the same as an ordinal number used for the component in another part in this specification or the scope of claims in some cases.

In this specification and the like, a document is a description of an event made by natural language unless otherwise specified. The document is converted into an electronic form to be machine readable. In this specification and the like, text includes one or a plurality of sentences.

### Embodiment 1

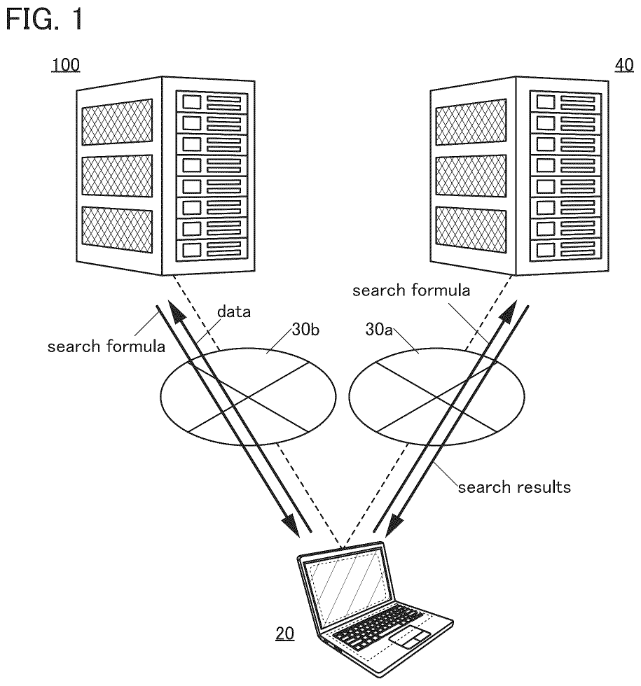

In this embodiment, a document search support system and a document search support method of one embodiment of the present invention will be described with reference to FIG. 1 to FIG. 5.

The document search support system of one embodiment of the present invention receives one or more documents (also referred to as a desired document(s)) included in a desired document group that is already grasped by a user, and performs learning of a classifier using the received document data. Next, the classifier is analyzed to extract two or more elements that are important for determining whether or not the document is a desired document. Next, with use of the two or more extracted elements, a first search formula is created such that the number of first search terms is small, the desired document includes at least one of the first search terms, and many other documents include none of the first search terms, and a second search formula is created such that the number of second search terms is small and many other documents include at least one of the second search terms. Then, a third search formula is created using the created two search formulae. In the above manner, a search formula for searching a desired document group can be provided.

Specifically, the document search support system of one embodiment of the present invention obtains data of a plurality of documents, receives a document that is part of the plurality of documents as a desired document, and classifies the plurality of documents into a first document group including the desired document and a second document group including the remaining document. Alternatively, the document search support system of one embodiment of the present invention may receive a document that is part of the plurality of documents as a desired document and a document that is another part of the plurality of documents as an undesired document. In this case, the plurality of documents are classified into the first document group including the desired document, the second document group including the undesired document, and a third document group including the remaining document.

Next, learning of the classifier is performed using, as learning data, a vector based on an element included in the data and a determination label on whether or not the document is the desired document in each document included in the first document group and the second document group, and the classifier is analyzed to extract two or more elements having high levels of importance.

As the element, one or more pieces of information included in the document itself and information linked to the document can be used. For example, one or both of a word included in a main text of the document and a classification assigned to the document are preferably used.

Next, the extracted elements are classified into a first group included in the first document group and a second group not included in the first document group. Next, with use of an element included in the first group, the first search formula is created such that the number of the first search terms is small, many of the documents in the first document group include at least one of the first search terms, and many of the documents in the second document group include none of the first search terms. With use of an element included in the second group, the second search formula is created such that the number of the second search terms is small and many of the documents in the second document group include at least one of the second search terms. Then, one or both of the third search formula using the first search formula and the second search formula and a result of searching the plurality of documents using the third search formula are output.

As each of the first search term and the second search term, one element itself, a combination of one or more logical operators (e.g., AND, OR, XOR, NOT, NAND, and NOR) and two or more elements, or the like can be used.

By searching with the first search formula, many of the desired documents received from the user can be extracted. By searching with the second search formula, many of the undesired documents can be extracted. Thus, for example, a (NOT search) formula that excludes search results of the second search formula from search results of the first search formula is preferably created as the third search formula.

The document search support system may use the search formula to search a document in a database and output the result. In addition, the user may input the output search formula into another search system to perform document search.

As described above, the document search support system of one embodiment of the present invention can create and present a search formula to search a desired document group on the basis of a document which the user has a grasp on whether or not the document is the desired document. Accordingly, the user does not need to create a search formula on their own, and the workload and the work time for document search can be reduced. Thus, necessary information can be obtained efficiently.

As a method for presenting the search formula and the search results, for example, one or both of displaying the search formula and the search results on a display screen of the user's terminal and outputting a file in a CSV format or the like can be performed.

The document search support system of one embodiment of the present invention may have a document search function. Note that the document search support system of one embodiment of the present invention may be part of a function of a document search system. Alternatively, the document search support system of one embodiment of the present invention may be independent of a document search system.

A document received by the document search support system of one embodiment of the present invention is not limited to a particular document and search of various types of documents can be supported. Examples of the document include patent application documentation, books, magazines, newspaper, contract agreement, academic papers (including treatises, theses, dissertations, essays, and articles), decision documents, terms and conditions, product manuals, novels, paper publications, white papers, technical documents, and business documents. As specific examples of patent application documentation, one or more of a specification, a scope of claims, and an abstract can be given.

Note that patent application documentation is sometimes described as an example of a document in the following description.

### <Document Search Support System 1>

FIG. 1 illustrates a system relating to document search that includes a document search support system 100.

In FIG. 1, a terminal 20 and a document search system 40 are connected to each other via a network 30a. The terminal 20 and the document search support system 100 are connected to each other via a network 30b.

The terminal 20 is an information terminal device, such as a personal computer (PC), used by the user and can also be referred to as a client PC. FIG. 1 illustrates a laptop PC as an example. Other examples of the terminal 20 include a tablet PC, a desktop PC, and a portable information terminal. Note that the number of terminals 20 is not limited to one and may be more than one.

The document search system 40 is a system capable of document search. FIG. 1 illustrates, as an example, a server computer capable of executing processing relating to document search. The document search system 40 is not limited to a special system, and an existing system, service, software, application, or the like is applicable.

The document search support system 100 is a system capable of creating a search formula with use of the document search support method of one embodiment of the present invention. FIG. 1 illustrates, as an example, a server computer capable of executing processing relating to the document search support method of one embodiment of the present invention.

As each of the networks 30a and 30b, a computer network such as the Internet, which is an infrastructure of the World Wide Web (WWW), an intranet, an extranet, a PAN (Personal Area Network), a LAN (Local Area Network), a CAN (Campus Area Network), a MAN (Metropolitan Area Network), a WAN (Wide Area Network), or a GAN (Global Area Network) can be used. For wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

Although the network 30a and the network 30b are separately illustrated in FIG. 1, the networks 30a and 30b may be the same. For example, both the networks 30a and 30b may be the Internet. The network 30a and the network 30b may be different from each other; for example, the document search system 40 and the terminal 20 may be connected to each other via the Internet (corresponding to the network 30a), and the document search support system 100 and the terminal 20 may be connected to each other via an internal LAN (corresponding to the network 30b).

The user can utilize the document search system 40 with use of dedicated software or application installed on the terminal 20, for example. Alternatively, the user can utilize the document search system 40 from a web browser with use of the terminal 20, for example.

The user can also utilize the document search support system 100 with use of dedicated software or application installed on the terminal 20, for example. Alternatively, the user can utilize the document search support system 100 from a web browser with use of the terminal 20, for example.

With the use of the terminal 20, the user inputs, to the document search support system 100, information on one or more documents that are grasped by the user as a desired document or an undesired document (data). The document search support system 100 creates a search formula using an element included in the document data (e.g., one or both of a word in the document and a classification assigned to the document) on the basis of the information of the input document, and outputs the search formula to the terminal 20 (search formula).

The user inputs the search formula created by the document search support system 100 to the document search system 40 using the terminal 20 (search formula). The document search system 40 outputs the search results obtained using the search formula to the terminal 20 (search results).

Without the document search support system 100, the user needs to create a search formula to be input to the document search system 40. With use of the document search support system 100, the user can omit the work of creating a search formula and can obtain necessary information efficiently.

Although FIG. 1 illustrates the document search support system 100 and the document search system 40 as different server computers, the present invention is not limited thereto; one server computer may serve as both the document search support system 100 and the document search system 40. The document search support system of one embodiment of the present invention can also have a document search function; thus, the document search support system 100 and the document search system 40 can be collectively regarded as the document search support system of one embodiment of the present invention. Some or all of the functions of the document search support system 100 and the document search system 40 may be provided in the terminal 20 utilized by the user.

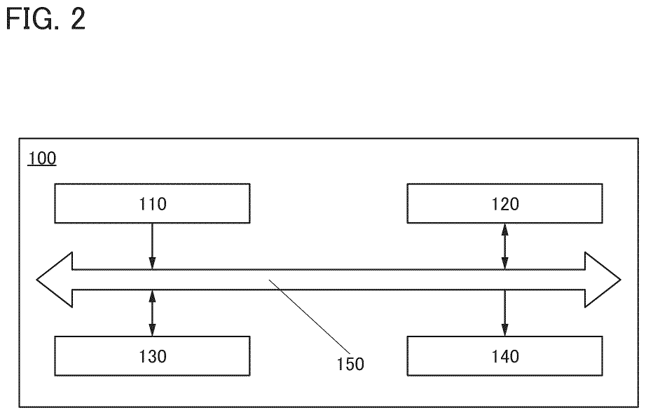

FIG. 2 shows a block diagram of the document search support system 100. The document search support system 100 includes a reception unit 110, a storage unit 120, a processing unit 130, an output unit 140, and a transmission path 150.

Note that in a block diagram attached to this specification, components are classified according to their functions and shown as independent blocks; however, it is practically difficult to completely separate the components according to their functions, and one component can relate to a plurality of functions. For example, a part of the processing unit 130 may function as the reception unit 110. In addition, one function can relate to a plurality of components. For example, processing performed by the processing unit 130 may be executed in different servers depending on the processing.

### [Reception Unit 110]

The reception unit 110 receives information on the document from the user while distinguishing whether or not the information on the document is included in the desired document group. For example, the document included in the desired document group and the document not included in the desired document group, which are already grasped by the user, can be received.

In the case where the document is included in a database or the like, the reception unit 110 can receive input of information specifying the document.

Examples of the information specifying the document include a title, a creator (including a writer, a contributor, an author, and the like), and various identification numbers of the document. In the case where the document is patent application documentation, examples of the information specifying the document include an application management number (including a unique internal number) for identifying the application, an application family management number for identifying an application family, an application number, a publication number, and a registration number.

In addition, input of text data such as the main text of the document may be received. In that case, the document that is not included in the database can be received as the desired document or undesired document.

The information on the document supplied to the reception unit 110 is supplied to one or both of the storage unit 120 and the processing unit 130 through the transmission path 150.

### [Storage Unit 120]

The storage unit 120 has a function of storing a program executed by the processing unit 130. The storage unit 120 may have a function of storing data (e.g., a calculation result, an analysis result, and an inference result) generated by the processing unit 130, data input to the reception unit 110, and the like.

Specifically, the storage unit 120 stores a program of the classifier that determines whether or not the document is the desired document by inputting the vector based on the element included in the document data.

As an algorithm that can be used for the classifier, a neural network, a decision tree, Lasso regression, and random forest can be given.

It is particularly preferable to use random forest or a decision tree, in which case the levels of importance of a feature value can be easily calculated.

In addition, a program for creating the search formula is stored in the storage unit 120.

The program optimizes a combination of features for creating the search formula using processing of combination optimization. As an algorithm that can be used for the program, a local search method, a greedy method, and a genetic algorithm can be given.

In particular, the genetic algorithm is preferable because it has a high degree of freedom of an evaluation function and is easy to define a desired search formula. In addition, it is also advantageous in that local optimization is easily prevented.

The storage unit 120 includes at least one of a volatile memory and a nonvolatile memory. As the volatile memory, a DRAM (Dynamic Random Access Memory), an SRAM (Static Random Access Memory), and the like can be given. Examples of the nonvolatile memory include an ReRAM (Resistive Random Access Memory, also referred to as a resistance-change memory), a PRAM (Phase change Random Access Memory), an FeRAM (Ferroelectric Random Access Memory), an MRAM (Magnetoresistive Random Access Memory, also referred to as a magnetoresistive memory), and a flash memory. The storage unit 120 may include a storage media drive. As the storage media drive, a hard disk drive (HDD), a solid state drive (SSD), or the like can be given.

The storage unit 120 may include a database storing document data. The document search support system 100 may have a function of extracting document data from a database existing outside the storage unit 120 or outside the system. Alternatively, the document search support system 100 may have a function of extracting data from both of its own database and an external database.

Instead of the database, a file server may be used. For example, in the case where a file included in a file server is used, the database preferably includes a path for the file held in the file server.

Examples of the document data included in the database include text data such as the main text of a document, a title, a creator (including a writer, a contributor, an author, and the like), a classification, and an identification number of a document. A document can be specified by comparing the document data included in the database with the information received by the reception unit 110.

In the case where the document is patent application documentation, for example, the document data preferably includes at least one piece of text data of a specification, a scope of claims, and an abstract. The document data preferably includes at least one of an application management number, an application family management number, an application number, a publication number, and a registration number as information specifying the document. There is no limitation on each status of the patent applications, i.e., whether or not it is published, whether or not it is pending in the Patent Office, and whether or not it is registered. For example, the database can include data of at least one of applications before examination, applications under examination, and registered applications or may include all of the data. The document data may include at least one piece of data such as an inventor, an applicant, a current owner, an application date, a priority date, a publication date, status, or patent classification (e.g., CPC, IPC, FI, or F-term). In addition, the document data may include unique internal information, and examples thereof include a subject, a category, a keyword, and a note relating to the document.

### [Processing Unit 130]

The processing unit 130 has a function of performing processing such as arithmetic operation, analysis, and inference with use of data supplied from one or both of the reception unit 110 and the storage unit 120. The processing unit 130 can supply generated data (e.g., an arithmetic operation result, an analysis result, and an inference result) to one or both of the storage unit 120 and the output unit 140.

The processing unit 130 has a function of obtaining data of the plurality of documents from one or both of the storage unit 120 and the database.

The processing unit 130 has a function of classifying the plurality of documents on the basis of the information received by the reception unit 110.

For example, in the case where the reception unit 110 receives only information on the documents included in the desired document group, these documents are referred to as the first document group (a set of documents selected as the desired documents) and the remaining documents are referred to as the second document group (a set of documents not selected as the desired documents).

In the case where the reception unit 110 receives information on both the documents included in the desired document group and the documents not included in the desired document group, a set of documents input as the desired documents is referred to as the first document group, a set of documents input as the undesired documents is referred to as the second document group, and the remaining documents are referred to as the third document group (a set of documents on which determination of whether or not the documents are the desired documents is not made).

The processing unit 130 has a function of vectorizing (quantifying) the document on the basis of the element included in the document data.

As described above, one or more of pieces of information included in the document itself and information linked to the document can be used as the element.

An example of the information included in the document itself is a word included in the main text of the document. For example, in the case where the document is patent application documentation, a word included in a text can be extracted from one or more of a specification, a scope of claims, and an abstract. For example, one or both of a morphological analysis and a compound word analysis can be performed to extract a word included in the text.

A predetermined part of speech may be extracted from the text. By using only a predetermined part of speech, the total number of elements can be reduced, and subsequent processing can be simplified. As the element, for example, a noun is preferably used. Consecutive nouns in one sentence may each be regarded as one element or may be collectively regarded as one element by combining them into a compound noun.

Examples of the information linked to the document include classifications assigned to the document. For example, a classification based on a classification method of a book or a patent classification can be used. In addition, unique information (e.g., a subject, a category, a keyword, and a note relating to the document) linked to the document can be used as the element.

It is particularly preferable to use one or both of a word and a classification as the element.

A variety of methods are given as a method for vectorizing the document using the element. Examples include one-hot representation (also referred to as one hot vector), TF-IDF (Term Frequency-Inverse Document Frequency), and Bag-of-Words.

In addition, for example, a model in which an element is converted into distributed representation is learned by machine learning and the distributed representation of the element can be obtained by using the model. A neural network is preferably used for the model.

In particular, the one-hot representation is preferably used. Generally, the number of appearances or the like of elements is not limited in document search in many cases. With the use of the one-hot representation, a document can be vectorized on the basis of whether or not a certain element is included in the document.

The processing unit 130 has a function of performing learning of the classifier with use of the vector based on the element and the determination label on whether or not the document is the desired document in each document as learning data. Furthermore, the processing unit 130 has a function of extracting the elements having high levels of importance from the elements by analyzing the classifier.

The processing unit 130 has a function of creating the search formula for searching the desired document group with use of the elements extracted as elements having high levels of importance. The processing unit 130 may have a function of searching the documents in the database using the search formula. Furthermore, the processing unit 130 has a function of outputting one or both of the search formula and the search results.

The processing unit 130 can include an arithmetic circuit, for example. The processing unit 130 can include, for example, a central processing unit (CPU). The processing unit 130 can also include a GPU (Graphics Processing Unit).

The processing unit 130 may include a microprocessor such as a DSP (Digital Signal Processor). The microprocessor may be constructed with a PLD (Programmable Logic Device) such as an FPGA (Field Programmable Gate Array) or an FPAA (Field Programmable Analog Array). The processing unit 130 may include a quantum processor. The processing unit 130 can interpret and execute instructions from various programs with use of a processor to process various kinds of data and control programs. The programs to be executed by the processor are stored in at least one of a memory region of the processor or the storage unit 120.

The processing unit 130 may include a main memory. The main memory includes at least one of a volatile memory such as a RAM (Random Access Memory) and a nonvolatile memory such as a ROM (Read Only Memory).

For example, a DRAM, an SRAM, or the like is used as the RAM, and a virtual memory space is assigned in the RAM and utilized as a working space of the processing unit 130. An operating system, an application program, a program module, program data, a look-up table, and the like that are stored in the storage unit 120 are loaded into the RAM for execution. The data, program, and program module that are loaded into the RAM are each directly accessed and operated by the processing unit 130.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

It is preferable to use artificial intelligence (AI) for at least part of processing of the document search support system.

It is particularly preferable to use an artificial neural network (ANN; hereinafter simply referred to as neural network) for the document search support system. The neural network is obtained with a circuit (hardware) or a program (software).

In this specification and the like, a neural network refers to a general model that is modeled on a biological neural network, determines the connection strength of neurons by learning, and has the capability of solving problems. A neural network includes an input layer, intermediate layers (hidden layers), and an output layer.

In the description of the neural network in this specification and the like, to determine a connection strength of neurons (also referred to as a weight coefficient) from the existing information is referred to as “learning” in some cases.

In this specification and the like, to draw a new conclusion from a neural network formed with the connection strength obtained by learning is referred to as “inference” in some cases.

For example, processing using AI can be used for one or more of the above vectorization of the document using the element, the classifier for determining whether or not the document is the desired document, and the creation of the search formula.

### [Output Unit 140]

The output unit 140 outputs information on the basis of the processing result in the processing unit 130. For example, the output unit 140 can supply at least one of an arithmetic operation result, an analysis result, and an inference result of the processing unit 130 to the outside of the document search support system 100. The output unit 140 can output information to a terminal, a display, or the like used by the user.

Specifically, the output unit 140 can output the search formula created by the processing unit 130. The result of searching the document included in the database with use of the search formula created by the processing unit 130 can be output.

### [Transmission Path 150]

The transmission path 150 has a function of transmitting data. Data transmission and reception among the reception unit 110, the storage unit 120, the processing unit 130, and the output unit 140 can be performed through the transmission path 150.

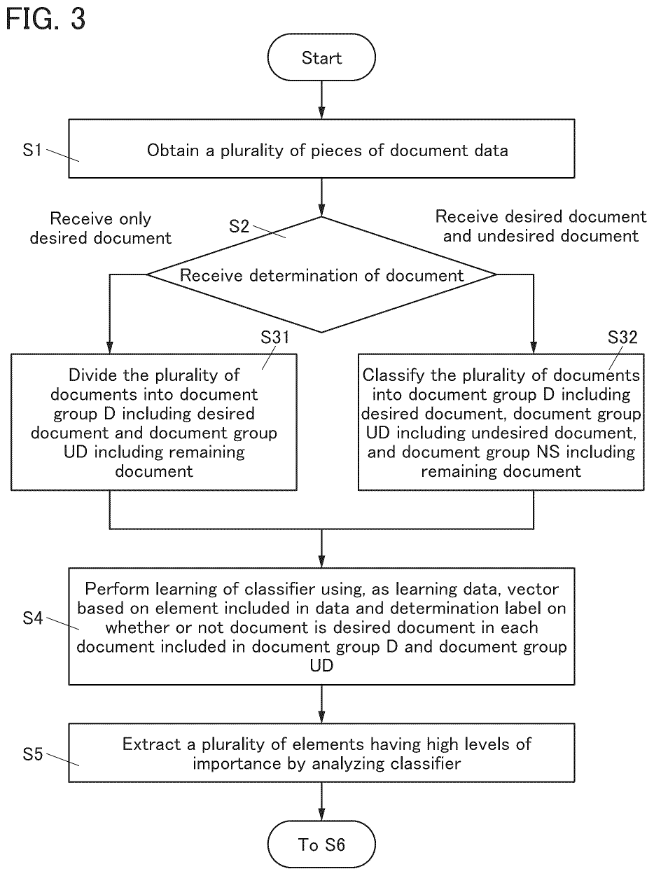

The document search support method and an output method of the document search support system of one embodiment of the present invention are described with reference to FIG. 3 to FIG. 5. Note that a display method using a display is given below as an example of the output method. That is, the method for displaying a result using the document search support method of one embodiment of the present invention is described below.

### <Document Search Support Method>

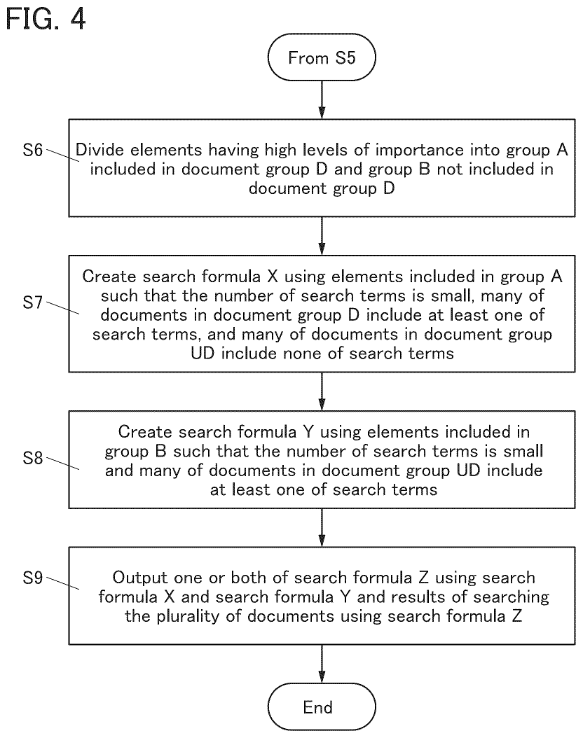

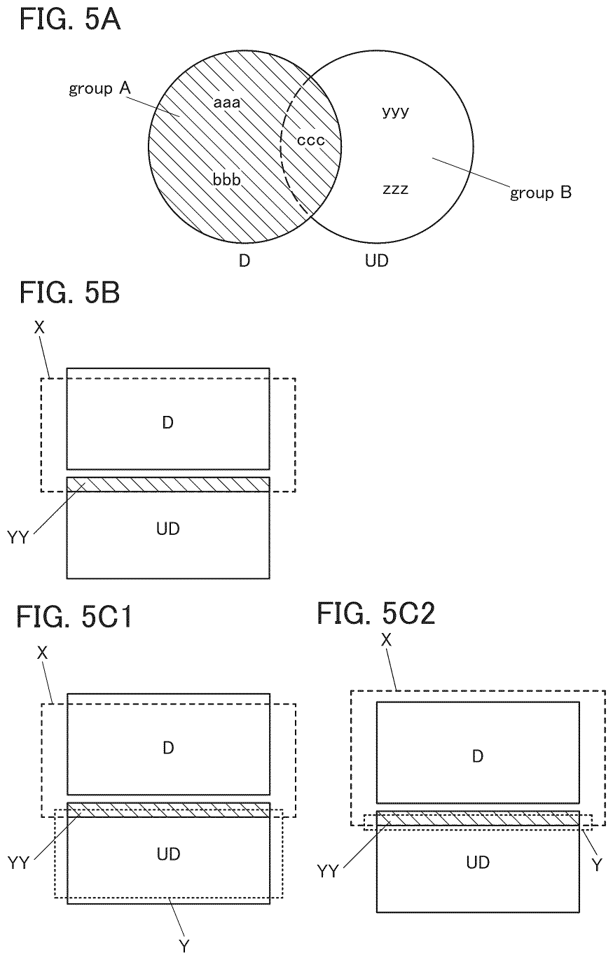

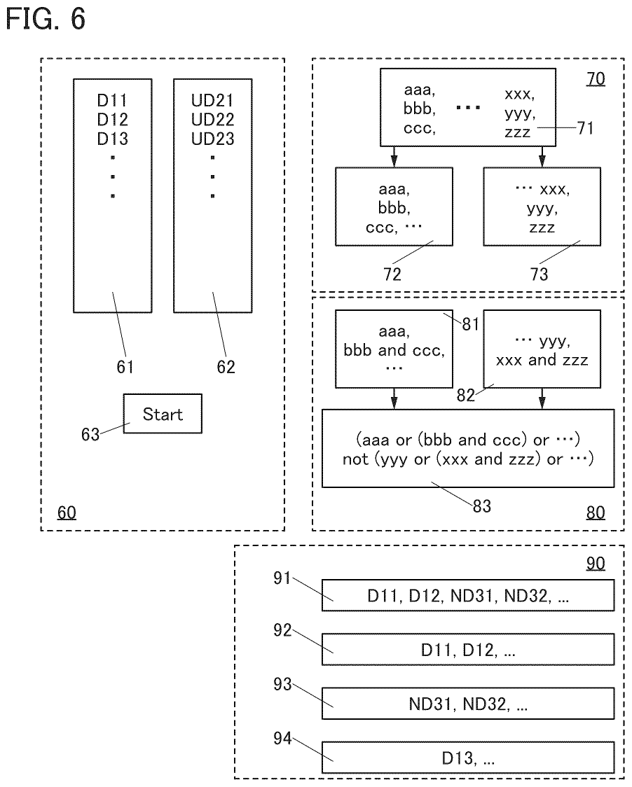

The document search support method of this embodiment includes processing composed of Step S1 to Step S9 illustrated in FIG. 3 and FIG. 4. FIG. 5 and FIG. 6 are diagrams each describing the document search support method. FIG. 6 can be regarded as an example of a graphical user interface (GUI) of the document search support system of this embodiment. Windows, text boxes, and the like in FIG. 6 are examples and there are no particular limitations thereon. A GUI can be constructed as a web page accessed by the user via a network. Alternatively, a GUI can be constructed as a screen of a program application executed on an information processing device such as a personal computer used by the user.

### [Step S1]

In Step S1, a plurality of pieces of document data are obtained. For example, the processing unit 130 can obtain the document data from the storage unit 120 or an external database. Document data input by a user may be obtained via the reception unit 110.

The document data includes at least data for specifying the document, data for generating a vector used for learning of the classifier, or data of the vector.

There is no particular limitation on the number of documents from which data is obtained in Step S1; for example, data may be obtained from some or all of search target documents.

Step S1 can be regarded as a step of obtaining data necessary for specifying a document using information to be received in Step S2.

For example, in the case where the user's search target is all the patent applications in Japan, data on all the patent applications in Japan may be obtained or some pieces of the data may be obtained. For example, in the case where the user inputs only information of their company's patent applications in Step S2, only data of the patent applications of their company may be obtained in Step S1.

In the case where the process proceeds to Step S31 later, the subsequent processing can be performed using all pieces of the document data obtained in Step S1; however, the larger the number of the documents to be used is, the larger the processing amount is, resulting in a longer processing time. Thus, the number of the documents from which data is obtained in Step S1 is preferably within a predetermined range.

Alternatively, in the case where the process proceeds to Step S32 later, the number of pieces of data used in the subsequent processing depends on the user's input content in Step S2; thus, there is no particular limitation on the number of the documents from which data is obtained in Step S1.

Step S1 can be regarded as a step of obtaining data to be used in Step S4. Before Step S4 is performed, the document is vectorized on the basis of an element included in the document data obtained in Step S1. Alternatively, in the case where the document is already vectorized, data of the vector is obtained in Step S1. Note that generating or obtaining data of the vector is performed at least before Step S4, and may be performed after Step S1.

### [Step S2]

In Step S2, the reception unit 110 receives determination of the document by the user via the terminal 20.

In FIG. 6, a region 60 is a region where input and operation are performed by the user. For example, two forms 61 and 62 (here, text boxes) are provided in the region 60; information specifying a document included in a desired document group that is grasped by the user is received through one of the two forms and information specifying a document not included in the desired document group that is grasped by the user is received through the other.

As described above, examples of the information specifying the document include a title, a creator, and various identification numbers of the document. In the case where the document is patent application documentation, examples of the information specifying the document include an application management number, an application family management number, an application number, a publication number, and a registration number. Input of text data such as the main text of the document may be received.

FIG. 6 illustrates an example in which desired documents D11, D12, D13, and the like are input to the form 61 using identification numbers or the like, and undesired documents UD21, UD22, UD23, and the like are input to the form 62 using identification numbers or the like. The user only needs to input at least information specifying a desired document to the form 61, and the form 62 may remain blank. Then, the user clicks or touches a button 63 (Start), so that the information input to the forms 61 and 62 is transmitted from the terminal 20 to the reception unit 110 of the document search support system 100.

Here, in the case where data is input to only the form 61, the process proceeds to Step S31, and in the case where data is input to both the form 61 and the form 62, the process proceeds to Step S32.

### [Step S31]

In Step S31, the plurality of documents from which data is obtained in Step S1 are divided into a document group D including the desired document and a document group UD including the remaining document.

In Step S2, the processing unit 130 can determine the document group D and the document group UD on the basis of the data received by the reception unit 110 from the terminal 20.

The document group D includes the documents (the documents D11, D12, D13, and the like) input to the form 61 by the user in Step S2. All other documents can be included in the document group UD. When the number of documents included in the document group UD is too large, the amount of processing in the subsequent processing is increased and processing time becomes longer. Accordingly, the upper limit may be set on the number of documents included in the document group UD. In that case, the documents included in the document group UD may be determined at random or may be determined on conditions such as a period or a field.

In the document search method of one embodiment of the present invention, it is not necessary for the user to input the undesired document; thus, the user can easily obtain a search formula for searching the desired document group with little effort.

### [Step S32]

In Step S32, the plurality of documents from which data is obtained in Step S1 are classified into the document group D including the desired document, the document group UD including the undesired document, and a document group NS including the remaining document.

In Step S2, the processing unit 130 can determine the document group D, the document group UD, and the document group NS on the basis of the data received by the reception unit 110 from the terminal 20.

The document group D includes the documents (the documents D11, D12, D13, and the like) input to the form 61 by the user in Step S2. The document group UD includes the documents (the documents UD21, UD22, UD23, and the like) input to the form 62 by the user in Step S2. All other documents can be included in the document group NS.

By using information on the undesired documents that are grasped by the user, a search formula with high search accuracy can be created in some cases. In particular, extraction of documents similar to the undesired documents with the created search formula can be inhibited.

Note that the number of document groups NS is not limited. A document included in the document group NS, for example, can be included as a search target in Step S9 of performing document search.

### [Step S4]

In Step S4, learning of the classifier is performed using, as learning data, the vector based on the element included in the data and a determination label on whether or not the document is the desired document in each document included in the document group D and the document group UD.

Specifically, the processing unit 130 performs processing using the classifier stored in the storage unit 120. The classifier has a function of determining whether or not the document is the desired document by inputting the vector based on the element included in the document data.

As described above, the vector of the document can be obtained from the database or generated by the processing unit 130.

In the case where the document is patent application documentation, one or more of a word included in a specification, a word included in a scope of claims, a word included in an abstract, a word included in any one, two, or all of a specification, a scope of claims, and an abstract, and IPC, CPC, FI, and F-term can be used as the element, for example.

For example, when the document is vectorized using a word included in the scope of claims or the abstract, a search formula that enables search in accordance with the main subject of the invention can be created. When the document is vectorized using a word included in the specification, a search formula that enables search in accordance with the content of the whole specification can be created. When the document is vectorized using IPC, CPC, FI, or F-term, it is possible to create a search formula while a bias in the document input to the form by the user (e.g., input of only patents of their company) is reduced. In addition, when the document is vectorized using IPC or CPC, a search formula that enables search under similar conditions across a plurality of countries can be created.

As described above, there is a possibility that the search formula to be created and the feature of the results of searching using the search formula vary depending on the selection of the element; thus, a plurality of elements may be combined to vectorize the document. In addition, the user may be allowed to select the element used for creating the search formula in accordance with the purpose or the like of searching the document.

A case where a word is used as the element is described below as an example.

In assigning the determination label, a label indicating that the document is the desired document is assigned to each of the documents included in the document group D and a label indicating that the document is the undesired document is assigned to each of the documents included in the document group UD.

### [Step S5]

In Step S5, a plurality of elements having high levels of importance are extracted by analyzing the classifier that has performed the learning in Step S4 in the processing unit 130.

The elements extracted in Step S5 are used for search terms used for creating the search formula. The larger the number of the search terms or the elements is, the higher the search accuracy of the search formula can be, whereas the smaller the number of the search terms or the elements is, the shorter the calculation time required for creating the search formula can be. Thus, the number of the elements extracted in Step S5 is greater than or equal to 2, preferably greater than or equal to 100, greater than or equal to 150, or greater than or equal to 200, and less than or equal to 2000, less than or equal to 1500, or less than or equal to 1000. Note that the number of the elements extracted in Step S5 may be less than 100 or more than 2000.

In Step S5, a predetermined number or proportion of the elements may be extracted in descending order of the importance level. The elements that satisfy an extraction criterion, for example, the elements whose importance levels are higher than a predetermined value or higher than or equal to a predetermined value, may be extracted. For another example, the elements whose importance levels are in the top 5%, 10%, or 15% may be extracted. Furthermore, the average and the standard deviation of the importance levels are calculated, and the elements each having a value higher than the average +2σ or higher than the average +3σ may be extracted.

For example, in the classifier using random forest, the importance level of a feature value can be calculated. Specifically, in the case where a word is used as the element, how much the word contributes to the determination result of the classifier can be quantified as the importance level. That is, it can be said that the higher the importance level is, the more the word contributes to determining whether or not the document input to the classifier is the desired document.

### [Step S6]

In Step S6, elements having high levels of importance are divided into a group A included in the document group D and a group B not included in the document group D in the processing unit 130.

For example, as illustrated in FIG. 5A, a word aaa and a word bbb included in only at least one of the documents included in the document group D and a word ccc included in both at least one of the documents included in the document group D and at least one of the documents included in the document group UD are classified as the group A. A word yyy and a word zzz that are not included in any of the documents included in the document group D (i.e., included in at least one of the documents included in the document group UD) are classified as the group B.

Note that information on analysis results of the classifier may be presented to the user. FIG. 6 illustrates an example in which the information on the analysis results of the classifier is displayed on a region 70.

In the region 70, a list 71 of the elements having high levels of importance is displayed as the result of the processing in Step S5. As the result of the processing in Step S6, a list 72 of the elements in the group A and a list 73 of the elements in the group B are also displayed. Note that there is no limitation on whether or not the lists 71, 72, and 73 are presented to the user. For example, it is possible to freely determine to display only the list 71 of the elements having high levels of importance or to display the list 71 of the elements having high levels of importance and the list 72 of the elements in the group A.

### [Step S7]

In Step S7, the processing unit 130 creates a search formula X using the elements included in the group A such that the number of search terms is small, many of the documents in the document group D include at least one of the search terms, and many of the documents in the document group UD include none of the search terms.

For example, one of the elements included in the group A can be used as one search term. Furthermore, one search term can be created by combining one or more logical operators (e.g., AND, OR, XOR, NOT, NAND, and NOR) and two or more of the elements included in the group A.

For example, the number of search terms is preferably two or more and two times or less the number of the elements included in the group A, further preferably smaller than the number of the elements included in the group A.

For example, it is preferable that the search formula X be created such that 50% or more of the documents included in the document group D include at least one of the search terms and 50% or more of the documents included in the document group UD include none of the search terms. It is further preferable that 60% or more, 70% or more, 80% or more, 90% or more, 95% or more, 98% or more, or 100% of the documents included in the document group D include at least one of the search terms. It is still further preferable that 60% or more, 70% or more, 80% or more, 90% or more, 95% or more, or 98% or more of the documents included in the document group UD include none of the search terms.

A genetic algorithm is preferably used to create the search formula X. Here, the number of search terms corresponds to the number of genes, the number of search formulae to be a candidate for the search formula X corresponds to the population, and the number of times the optimization calculation is repeated can be regarded as the number of generations. The larger each of the number of genes, the population, and the number of generations is, the higher the accuracy of the search formula X can be, and the smaller each of the number of genes, the population, and the number of generations is, the shorter the calculation time required for creating the search formula X can be. The number of genes, the population, and the number of generations are each preferably greater than or equal to 50, greater than or equal to 100, greater than or equal to 150, or greater than or equal to 200, and less than or equal to 1000, less than or equal to 700, or less than or equal to 500. Note that the number of genes, the population, and the number of generations may each be less than 50 or more than 1000.

The search term used in the search formula X is a search term that constitutes a search formula Z to be created in Step S9. In particular, the search formula X serves as a part for extracting the plurality of documents including the desired document. Thus, by creating the search formula X such that the number of search terms is as small as possible, it is possible to inhibit an excessive increase in the number of documents to be extracted.

Since the document group D includes the desired documents, it is desirable that all of these documents can be extracted by the search formula X. Alternatively, the number of extracted documents is preferably as large as possible.

In the case where Step S32 is performed, the document group UD includes the undesired documents; thus, it is desirable that all of these documents not be extracted by the search formula X. Alternatively, the number of extracted documents is preferably as small as possible.

In the case where Step S31 is performed, the document group UD includes a document on which determination of whether or not the document is the desired document is not made, and it can be said that the document group UD latently includes an undesired document. Thus, also in this case, the number of documents extracted by the search formula X from the document group UD is preferably as small as possible.

### [Step S8]

In Step S8, the processing unit 130 creates a search formula Y using the elements included in the group B such that the number of search terms is small and many of the documents in the document group UD include at least one of the search terms.

For example, one of the elements included in the group B can be used as one search term. Furthermore, one search term can be created by combining one or more logical operators and two or more of the elements included in the group B.

For example, the number of search terms is preferably two or more and two times or less the number of the elements included in the group B, further preferably smaller than the number of the elements included in the group B.

For example, it is preferable that the search formula Y be created such that 50% or more of the documents included in the document group UD include at least one of the search terms. It is further preferable that 60% or more, 70% or more, 80% or more, 90% or more, 95% or more, or 98% or more of the documents included in the document group UD include at least one of the search terms.

The search formula Y is preferably created using a genetic algorithm like the search formula X.

The search term used in the search formula Y is a search term that constitutes the search formula Z to be created in Step S9. In particular, the search formula Y serves as a part for removing an unnecessary document (what is called noise) from the documents extracted by the search formula X. By creating the search formula Y such that the number of search terms is as small as possible, it is possible to appropriately remove the noise.

Since the elements included in the group B are not included in the document group D, the documents included in the document group D are not extracted by the search formula Y.

In the case where Step S32 is performed, the document group UD includes the undesired documents; thus, it is desirable that all of these documents can be extracted by the search formula Y. Alternatively, the number of extracted documents is preferably as large as possible.

In the case where Step S31 is performed, the document group UD includes a document on which determination of whether or not the document is the desired document is not made, and it can be said that the document group UD latently includes an undesired document. Thus, also in this case, the number of documents extracted by the search formula Y from the document group UD is preferably as large as possible.

Here, either Step S7 or Step S8 may be performed earlier, calculations in Step S7 and Step S8 may be performed collectively and concurrently, or Step S7 and Step S8 may be performed concurrently in parallel. In the case where Step S7 and Step S8 are performed concurrently, it is preferable to perform them in parallel, in which case the calculation amount can be reduced. It is particularly preferable that Step S7 be performed first and Step S8 be performed using the results obtained in Step S7. This allows the calculation amount to be reduced and the accuracy of the search formula to be improved in Step S8.

Specifically, as illustrated in FIG. 5B, it is probable that while many (or all) of the documents in the document group D can be extracted by the search formula X, part of the document group UD (referred to as a document group YY) is extracted. It is desirable that all documents included in the document group YY can be extracted by the search formula Y. Alternatively, the number of extracted documents is preferably as large as possible. In other words, the document group YY includes the documents extracted by the search formula X from the document group UD. It is preferable that the search formula Y be created such that 50% or more of the documents included in the document group YY include at least one of the search terms. It is further preferable that 60% or more, 70% or more, 80% or more, 90% or more, 95% or more, 98% or more, or 100% of the documents included in the document group YY include at least one of the search terms.

When Step S7 and Step S8 are independently performed, whether or not a document is extracted by the search formula X is not taken into consideration as illustrated in FIG. 5C1; thus, the search formula Y is created so as to extract a large number of documents, in addition to the document group YY, from the document group UD. Accordingly, unnecessary calculation might be required or the accuracy of the search formula Y might be decreased.

Thus, as illustrated in FIG. 5C2, it is preferable to create the search formula Y using the elements included in the group B such that the number of search terms is small and many of the documents in the document group YY (corresponding to the documents extracted by the search formula X from the document group UD) include the search term.

### [Step S9]

In Step S9, one or both of the search formula Z using the search formula X and the search formula Y and the results of searching the plurality of documents using the search formula Z are output.

The search formula Z created by the processing unit 130 and the results of the search performed by the processing unit 130 are supplied to the terminal 20 via the output unit 140.

FIG. 6 illustrates an example in which information on the search formula is displayed on a region 80 and information on the search results is displayed on a region 90.

In the region 80, a list 81 of search terms included in the search formula X, a list 82 of search terms included in the search formula Y, and a search formula 83 (corresponding to the search formula Z) are displayed.

In the list 81, “aaa”, which is a search term composed of one element, “bbb and ccc”, which is a search term composed of a logical operator and two elements, and the like are displayed.

In the list 82, “yyy”, which is a search term composed of one element, “xxx and zzz”, which is a search term composed of a logical operator and two elements, and the like are displayed.

At least the search formula 83 is preferably displayed on the region 80. An operator or the like differs between document search systems. Thus, a search formula may be created for each document search system and a plurality of search formulae may be displayed. As an example of the search formula 83, a (NOT search) formula that excludes search results of the search formula Y from search results of the search formula X is given.

The region 90 displays search results of the documents in the database using the search formula 83. The search target includes the document group NS that is not used in any of Step S4 to Step S8, in addition to the document group D and the document group UD. Furthermore, a document that is not obtained in Step S1 may be included.

In the region 90, the documents D11, D12, ND31, ND32, and the like are illustrated as a document 91 extracted by the search formula 83. The documents D11, D12, and the like in the document 91 are illustrated as a document 92 matching the desired documents (the documents input to the form 61) that are grasped by the user. The documents ND31, ND32, and the like in the document 91 are illustrated as a document 93 that is not grasped by the user as the desired documents. The document D13 and the like are illustrated as a document 94 that is not extracted by the search formula 83 from the desired documents (the documents input to the form 61) that are grasped by the user.

In this manner, the search results using the search formula 83 are preferably compared with the information received from the user in Step S2 and displayed. This allows the user to easily evaluate the accuracy of the search formula 83. By checking the contents of the document 93, a new document included in the desired document group can be grasped. In the case where an undesired document is extracted as the document 93, the document may be added to the form 62 and creation of a search formula may be executed again.

As described above, with the document search support system of one embodiment of the present invention, it is possible to create the search formula for searching the desired document group by only inputting information on the desired document that is already grasped by the user. Accordingly, the user does not need to create a search formula on their own, and the workload and the work time for document search can be reduced. Thus, necessary information can be obtained efficiently.

This embodiment can be combined with any of the other embodiments as appropriate. In the case where a plurality of structure examples are shown in one embodiment in this specification, the structure examples can be combined as appropriate.

### Embodiment 2

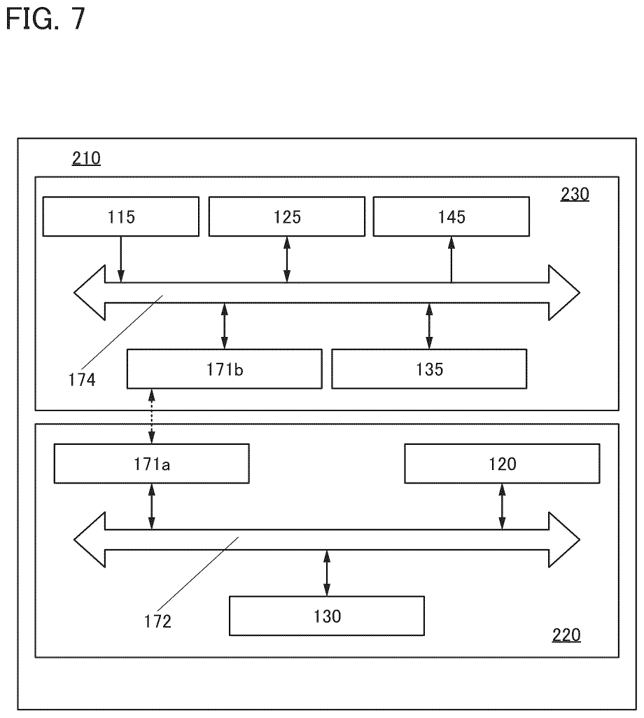

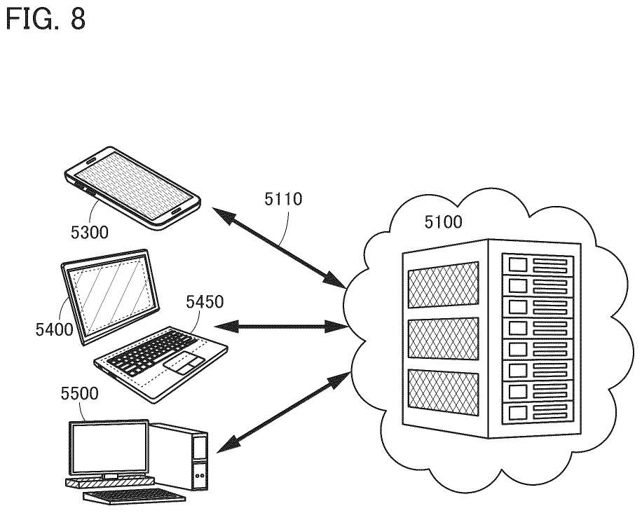

In this embodiment, a document search support system of one embodiment of the present invention will be described with reference to FIG. 7 and FIG. 8.

### <Document Search Support System 2>

FIG. 7 shows a block diagram of a document search support system 210. The document search support system 210 includes a server 220 and a terminal 230 (e.g., a personal computer). Note that the description of <Document search support system 1> in Embodiment 1 can be referred to for the same components as those in the document search support system 100 shown in FIG. 1.

The server 220 includes a communication unit 171a, a transmission path 172, the storage unit 120, and the processing unit 130. Although not shown in FIG. 7, the server 220 may further include at least one of a reception unit, a database, an output unit, an input unit, and the like.

The terminal 230 includes a communication unit 171b, a transmission path 174, an input unit 115, a storage unit 125, a processing unit 135, and a display unit 145. Examples of the terminal 230 include various personal computers such as a tablet personal computer, a laptop personal computer, and a desktop personal computer and various portable information terminals. The terminal 230 may be a desktop personal computer without the display unit 145 and may be connected to a monitor functioning as the display unit 145, or the like.

The user of the document search support system 210 can input information on the desired document and the undesired document from the input unit 115 of the terminal 230 to the server 220. Furthermore, the document data or the like can be input. These input contents are transmitted from the communication unit 171b to the communication unit 171a.

The information received by the communication unit 171a is held in a memory included in the processing unit 130 or the storage unit 120 via the transmission path 172. The information may be supplied from the communication unit 171a to the processing unit 130 via a reception unit (see the reception unit 110 illustrated in FIG. 2). Alternatively, it can be said that the communication unit 171a corresponds to the reception unit 110 illustrated in FIG. 2.

In the document search support method described in Embodiment 1, various types of processing in Step S4 (learning of the classifier), Step S5 (analysis of the classifier), and Step S6 to Step S9 (creation of the search formulae) are performed in the processing unit 130. These types of processing require extremely high processing capacity, and thus are preferably performed in the processing unit 130 included in the server 220. The processing unit 130 preferably has higher processing capacity than the processing unit 135. Other steps are preferably performed in the processing unit 130, and some of the steps may be performed in the processing unit 135.

A processing result of the processing unit 130 is held in the memory included in the processing unit 130 or the storage unit 120 via the transmission path 172. After that, the processing result is output from the server 220 to the display unit 145 of the terminal 230. The processing result is transmitted from the communication unit 171a to the communication unit 171b. On the basis of the processing result of the processing unit 130, various kinds of data included in a database may be transmitted from the communication unit 171a to the communication unit 171b. The processing result may be supplied from the processing unit 130 to the communication unit 171a via an output unit (the output unit 140 illustrated in FIG. 2). Alternatively, it can be said that the communication unit 171a corresponds to the output unit 140 illustrated in FIG. 2.

[Communication Unit 171a and Communication Unit 171b]

The server 220 and the terminal 230 can transmit and receive data with use of the communication unit 171a and the communication unit 171b. As the communication unit 171a and the communication unit 171b, a hub, a router, a modem, or the like can be used. Data may be transmitted and received through wire communication or wireless communication (e.g., radio waves or infrared rays).

As a communication method between the communication unit 171a and the communication unit 171b, structures that can be used for the networks 30a and 30b described in Embodiment 1 as an example can be employed.

### [Transmission Path 172 and Transmission Path 174]

The transmission path 172 and the transmission path 174 have a function of transmitting data. The communication unit 171a, the storage unit 120, and the processing unit 130 can transmit and receive data via the transmission path 172. The communication unit 171b, the input unit 115, the storage unit 125, the processing unit 135, and the output unit 140 can transmit and receive data via the transmission path 174.

### [Input Unit 115]

The input unit 115 can be used when the user designates document data, a block, or the like. For example, the input unit 115 can have a function of operating the terminal 230; specific examples thereof include a mouse, a keyboard, a touch panel, a microphone, a scanner, and a camera.

The document search support system 210 may have a function of converting audio data into text data. For example, at least one of the processing unit 130 and the processing unit 135 may have this function.

The document search support system 210 may have an optical character recognition (OCR) function. This enables characters included in image data to be recognized and text data to be created. For example, at least one of the processing unit 130 and the processing unit 135 may have this function.

### [Storage Unit 125]

The storage unit 125 may store one or both of the document data and the data supplied from the server 220. The storage unit 125 may include at least part of the data that can be included in the storage unit 120.

### [Processing Unit 130 and Processing Unit 135]

The processing unit 135 has a function of performing arithmetic operation or the like with use of data supplied from the communication unit 171b, the storage unit 125, the input unit 115, or the like. The processing unit 135 may have a function of executing at least part of processing that can be performed by the processing unit 130.

Each of the processing unit 130 and the processing unit 135 can include one or both of a transistor including a metal oxide in its channel formation region (OS transistor) and a transistor including silicon in its channel formation region (Si transistor).

In this specification and the like, a transistor including an oxide semiconductor or a metal oxide in a channel formation region is referred to as an oxide semiconductor transistor or an OS transistor. A channel formation region of an OS transistor preferably includes a metal oxide.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element Mare boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element Mis, for example, an element that has high bonding energy with oxygen. The element M is, for example, an element that has higher bonding energy with oxygen than that of indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The semiconductor layer may be a metal oxide that does not contain indium and contains zinc, a metal oxide that does not contain indium and contains gallium, a metal oxide that does not contain indium and contains tin, or the like, e.g., zinc tin oxide or gallium tin oxide.

The processing unit 130 preferably includes an OS transistor. The OS transistor has an extremely low off-state current; thus, with use of the OS transistor as a switch for retaining electric charge (data) that has flowed into a capacitor functioning as a storage element, a long data retention period can be ensured. When at least one of a register and a cache memory included in the processing unit 130 has such a feature, the processing unit 130 can be operated only when needed, and otherwise can be off while information processed immediately before turning off the processing unit 130 is stored in the storage element. In other words, normally-off computing is possible and the power consumption of the document search support system can be reduced.

### [Display Unit 145]

The display unit 145 has a function of displaying an output result. Examples of the display unit 145 include a liquid crystal display device and a light-emitting display device. Examples of light-emitting elements that can be used in the light-emitting display device include an LED (Light Emitting Diode), an OLED (Organic LED), a QLED (Quantum-dot LED), and a semiconductor laser. It is also possible to use, as the display unit 145, a display device using a MEMS (Micro Electro Mechanical Systems) shutter element, an optical interference type MEMS element, or a display device using a display element employing a microcapsule method, an electrophoretic method, an electrowetting method, an Electronic Liquid Powder (registered trademark) method, or the like, for example.

FIG. 8 is a conceptual diagram of the document search support system of this embodiment.

The document search support system illustrated in FIG. 8 includes a server 5100 and terminals (also referred to as electronic devices). Communication between the server 5100 and each terminal is conducted via an Internet connection 5110.

The server 5100 is capable of performing arithmetic operation using data input from the terminal via the Internet connection 5110. The server 5100 is capable of transmitting an arithmetic operation result to the terminal via the Internet connection 5110. Accordingly, the burden of arithmetic operation on the terminal can be reduced.

In FIG. 8, an information terminal 5300, an information terminal 5400, and an information terminal 5500 are illustrated as the terminals. The information terminal 5300 is an example of a portable information terminal such as a smartphone. The information terminal 5400 is an example of a tablet terminal. When the information terminal 5400 is connected to a housing 5450 with a keyboard, the information terminal 5400 can be used as a laptop information terminal. The information terminal 5500 is an example of a desktop information terminal.

With such a structure, the user can access the server 5100 from the information terminal 5300, the information terminal 5400, the information terminal 5500, and the like. Then, through the communication via the Internet connection 5110, the user can receive a service offered by an administrator of the server 5100. Examples of the service include a service with use of the document search support method of one embodiment of the present invention. In the service, artificial intelligence may be utilized in the server 5100.

In the server 5100, it is preferable that the document search can be performed using a search formula created using the document search support method of one embodiment of the present invention. Alternatively, as described with reference to FIG. 1, the document search using the search formula may be performed in a server different from the server 5100.

This embodiment can be combined with the other embodiment as appropriate.

### REFERENCE NUMERALS

20: terminal, 30a: network, 30b: network, 40: document search system, 60: region, 61: form, 62: form, 63: button, 70: region, 71: list, 72: list, 73: list, 80: region, 81: list, 82: list, 83: search formula, 90: region, 91: document, 92: document, 93: document, 94: document, 100: document search support system, 110: reception unit, 115: input unit, 120: storage unit, 125: storage unit, 130: processing unit, 135: processing unit, 140: output unit, 145: display unit, 150: transmission path, 171a: communication unit, 171b: communication unit, 172: transmission path, 174: transmission path, 210: document search support system, 220: server, 230: terminal, 5100: server, 5110: Internet connection, 5300: information terminal, 5400: information terminal, 5450: housing, 5500: information terminal

1. A method for supporting document search comprising:
obtaining data of a plurality of documents;
receiving a first document of the plurality of documents as a desired document;
classifying the plurality of documents into a first document group comprising the desired document and a second document group comprising a second document of the plurality of documents;
performing learning of a classifier using, as learning data, a vector based on an element of a plurality of elements included in the data and a determination label on whether or not a document of the plurality of documents is the desired document;
analyzing the classifier to extract two or more elements of the plurality of elements having high levels of importance from the plurality of elements;
classifying the extracted two or more elements into a first group included in the first document group and a second group not included in the first document group;
generating first search terms using an element of the two or more elements included in the first group;
creating a first search formula using the first search terms;
generating second search terms using an element included in the second group;
creating a second search formula using the second search terms; and
outputting one or both of a third search formula created using the first search formula and the second search formula and a result of searching the plurality of documents using the third search formula,
wherein a number of the first search terms is two or more and two times or less than a number of the two or more elements of the first group,
wherein, in the first search formula, 50% or more of documents included in the first document group comprise at least one of the first search terms and 50% or more of documents included in the second document group comprise none of the first search terms,
wherein a number of the second search terms is two or more and two times or less than a number of two or more elements of the second group, and
wherein, in the second search formula, 50% or more of documents included in the second document group comprise at least one of the second search terms.

2. A method for supporting document search comprising:
obtaining data of a plurality of documents;
receiving a first document of the plurality of documents as a desired document and receiving a second document of the plurality of documents as an undesired document;
classifying the plurality of documents into a first document group comprising the desired document, a second document group comprising the undesired document, and a third document group comprising a third document of the plurality of documents;
performing learning of a classifier using, as learning data, a vector based on an element of a plurality of elements included in the data and a determination label on whether or not a document of the plurality of documents is the desired document in the first document group and the second document group;
analyzing the classifier to extract two or more elements of the plurality of elements having high levels of importance from the plurality of elements;
classifying the extracted two or more elements into a first group included in the first document group and a second group not included in the first document group;
generating first search terms using an element of the two or more elements included in the first group;
creating a first search formula using the first search terms;
generating second search terms using an element included in the second group;
creating a second search formula using the second search terms; and
outputting one or both of a third search formula created using the first search formula and the second search formula and a result of searching the plurality of documents using the third search formula,
wherein a number of the first search terms is two or more and two times or less than a number of the two or more elements of the first group,
wherein, in the first search formula, 50% or more of documents included in the first document group comprise at least one of the first search terms and 50% or more of documents included in the second document group comprise none of the first search terms,
wherein a number of the second search terms is two or more and two times or less than a number of two or more elements of the second group, and
wherein, in the second search formula, 50% or more of documents included in the second document group comprise at least one of the second search terms.

3. The method for supporting document search according to claim 1,
wherein the second search formula is created after the first search formula, and
wherein, in the second search formula, 50% or more of documents extracted by the first search formula from the second document group comprise at least one of the second search terms.

4. The method for supporting document search according to claim 1,
wherein the classifier is a classifier using random forest.

5. The method for supporting document search according to claim 1,
wherein the first search formula is created using a genetic algorithm.

6. The method for supporting document search according to claim 1,
wherein the second search formula is created using a genetic algorithm.

7. The method for supporting document search according to claim 1,
wherein the element of the plurality of elements included in the data is a word.

8. A device comprising a processor,
wherein the device is configured to execute the method for supporting document search according to claim 1.

9. A document search support system comprising:
a reception unit;
a storage unit comprising a memory;
a processing unit; and
an output unit,
wherein the reception unit is configured to receive a plurality of documents including a desired document,
wherein the storage unit is configured to store a classifier,
wherein the processing unit is configured to:
generate a vector on the basis of an element of a plurality of elements included in data of each of the plurality of documents;
assign a determination label to a first document of the plurality of documents on whether or not the first document is the desired document;
perform learning of the classifier using the vector and the determination label as learning data;
analyze the classifier and extract two or more elements of the plurality of elements having high levels of importance; and
create a search formula using the two or more elements of the plurality of elements having high levels of importance, and
wherein the output unit is configured to output the search formula.

10. The document search support system according to claim 9,
wherein the processing unit is configured to
classify the plurality of documents into a first document group comprising the desired document and a second document group comprising a second document which is not the desired document.

11. A document search support system according to claim 9,
wherein the plurality of documents further comprises an undesired document,
wherein the processing unit is configured to
classify the plurality of documents into a first document group comprising the desired document, a second document group comprising the undesired document, and a third document group comprising a second document which is different from the desired document and the undesired document.

12. (canceled)
